(19) United States
(12) Patent Application Publication
(10) Pub. No.: US 2010/0113652 A1
(43) Pub. Date: May 6, 2010

(54) Environmentally-Friendly Shoe Bottom

(76) Inventor: Zhongqi Lian, Guangzhou (CN)

Correspondence Address: GLOBAL IP SERVICES, 7285 W. Eagle Court, Winton, CA, 95388, US

(21) Appl. No.: 12/266,014

(22) Filed: Nov. 6, 2008

(51) Int. Cl. C08K 13/00; B29C 43/02

(52) U.S. Cl. 524/9; 264/331.15

(57) ABSTRACT

The present invention relates to an environmentally-friendly shoe bottom, which mainly comprises thermoplastic elastomer (TPE), polystyrene (PS), polyethylene (PE), softening oil, cornstalk, wheat stalk, rice straw, and rice bran. The main advantages of the environmentally-friendly shoe bottom are that it uses the agriculturally waste cornstalk, wheat stalk, rice straw, and rice bran to replace calcium carbonate and zinc stearate included in the traditional sole material TPR and retains the physical properties of the traditional TPR. Further, the environmentally-friendly shoe bottom may also naturally decompose, which achieves the purposes of protecting the ecological environment and efficiently utilizing the agriculturally waste resource.

### FIELD OF THE INVENTION

The present invention relates to an environmentally-friendly shoe bottom, and especially to an environmentally-friendly shoe bottom generated using agriculturally waste cornstalk, wheat stalk, rice straw, and rice bran.

### BACKGROUND OF THE INVENTION

For recent years, along with continual progress of science and technology, sole materials have not been limited to leather, rubber and so on. Presently, various kinds of sole materials may be bought at markets, with different designs, such as rubber, thermoplastic rubber, polyurethane or thermoplastic polyurethane and so on. Thermoplastic rubber is applied to sole materials more and more widely because of its price predominance and advantages. However, current TPR technical resource is still traditional at home and abroad and it is a traditional industry mainly based on TPE and calcium carbonate, which components still include some substances harmful to human. For example, chemicals calcium carbonate and zinc stearate are added to TPR, wherein zinc stearate generates unpleasant smell after combusting, and some residues are remained after combusting chemicals calcium. So the TPR produced by the traditional industry will relieve micro amount of chemical smell of zinc stearate after combusting.

When the things are dissolved in water to decompose after they are combusted, there are some residues (i.e. deposition) which can't decompose. However, now my company is researching to utilize the things such as cornstalk, wheat stalk, rice straw, and rice bran, abandoned by peasants after reaping, to replace calcium carbonate and zinc stearate included in components of the traditional TPR. Such TPR not only has no effect to the original physical properties of the product, but also may remove harmful chemical substances. Further, reusing the things abandoned by peasants after reaping to achieve the purposes of protecting ecological environment and efficiently utilizing the waste resource.

### SUMMARY OF THE INVENTION

The subject of the present invention is to provide an environmentally-friendly shoe bottom, which mainly uses the agriculturally waste cornstalk, wheat stalk, rice straw, and rice bran to replace calcium carbonate and zinc stearate included in the traditional TPR, still retaining the original physical properties of the TPR.

### THE TECHNICAL SOLUTION OF THE INVENTION IS

soaking cornstalks and wheat stalks in clear water, then bleaching them, then drying them by sun and then crushing the dried cornstalks and wheat stalks together with the rice bran and rice straws into mixed fragments; die casting at a high temperature the mixed fragments together with TPE, PS, PE and softening oil to become shoe bottom.

A another process is that further milling the mixed fragments to be mixed powder, then die casting at a high temperature the mixed power together with TPE, PS, PE and softening oil to become shoe bottom

the temperature of die casting at a high temperature being 100 to 250° C. and its heating time being 10 to 20 minutes;

the fineness of the power milling being 600 to 800 meshes;

each component having a weight ratio of as follows:

thermoplastic elastomer (TPE) 50% to 60%, polystyrene (PS) 10% to 20%, polyethylene (PE) 2% to 5%, softening oil 10% to 20%, cornstalk 2% to 8%, wheat stalk 2% to 8%, rice straw 2% to 8%, and rice bran 2% to 8%.

The combined percent of the cornstalk, the wheat stalk, the rice straw and the rice bran is ≦28%.

Advantageous effects of the invention are: that the invention processes the wheat stalk, rice straw, and rice bran, abandoned by peasants after reaping, to replace calcium carbonate and zinc stearate included in the traditional TPR material, which protects the ecological environment and efficiently utilizes the waste resource, and brings additional income to peasants; and that because unpleasant smell and residues may be generated after calcium carbonate and zinc stearate are combusted, but no residues and harmful smell may remain after crops are combusted, the invention avoids the harmful aspects of these chemicals calcium carbonate and zinc stearate to human, and meanwhile the TPR produced by the invention also retain the original physical properties of the traditional TPR.

### DETAILED DESCRIPTION OF THE INVENTION

The invention is further described in detail by following embodiments, wherein these embodiments are just used to illuminate the invention, and not to limit the scope of the invention.

### Embodiment 1

Soak in clear water, bleach, dry by sun and then crush the recovered cornstalk and wheat stalk; then mill the crushed cornstalk and wheat stalk together with the rice bran and rice straw into powder; die cast at a high temperature, pump into tablets and mold the milled powder materials or the raw materials which aren't milled into powder material, together with TPE, PS, PE and the softening oil;

the temperature of die casting at a high temperature is 100° C. and its heating time is 20 minutes;

the fineness of the power milling is 600 meshes;

each component has a weight ratio of as follows:

TPE 50%, PS 10%, PE 5%, the softening oil 20%, the cornstalk 4%, the wheat stalk 3%, the rice straw 3%, and the rice bran 3%.

### Embodiment 2

Soak in clear water, bleach, dry by sun and then crush the recovered cornstalk and wheat stalk; then mill the crushed cornstalk and wheat stalk together with the rice bran and rice straw into powder; die cast at a high temperature, pump into tablets and mold the milled powder materials or the raw materials which aren't milled into powder material, together with TPE, PS, PE and the softening oil;

the temperature of die casting at a high temperature is 150° C. and its heating time is 15 minutes;

the fineness of the power milling is 700 meshes;

each component has a weight ratio of as follows:

TPE 60%, PS 20%, PE 2%, the softening oil 10%, the cornstalk 2%, the wheat stalk 2%, the rice straw 2%, and the rice bran 2%.

### Embodiment 3

Soak in clear water, bleach, dry by sun and then crush the recovered cornstalk and wheat stalk; then mill the crushed cornstalk and wheat stalk together with the rice bran and rice straw into powder; die cast at a high temperature, pump into tablets and mold the milled powder materials or the raw materials which aren't milled into powder material, together with TPE, PS, PE and the softening oil;

the temperature of die casting at a high temperature is 200° C. and its heating time is 10 minutes;

the fineness of the power milling is 800 meshes;

each component has a weight ratio of as follows:

TPE 55%, PS 15%, PE 3%, the softening oil 15%, the cornstalk 3%, the wheat stalk 3%, the rice straw 3%, and the rice bran 3%.

### Embodiment 4

Soak in clear water, bleach, dry by sun and then crush the recovered cornstalk and wheat stalk; then mill the crushed cornstalk and wheat stalk together with the rice bran and rice straw into powder; die cast at a high temperature, pump into tablets and mold the milled powder materials or the raw materials which aren't milled into powder material, together with TPE, PS, PE and the softening oil;

the temperature of die casting at a high temperature is 250° C. and its heating time is 10 minutes;

the fineness of the power milling is 700 meshes;

each component has a weight ratio of as follows:

TPE 50%, PS 12%, PE 3%, the softening oil 10%, the cornstalk 8%, the wheat stalk 7%, the rice straw 5%, and the rice bran 5%.

### Embodiment 5

Soak in clear water, bleach, dry by sun and then crush the recovered cornstalk and wheat stalk; then mill the crushed cornstalk and wheat stalk together with the rice bran and rice straw into powder; die cast at a high temperature, pump into tablets and mold the milled powder materials or the raw materials which aren't milled into powder material, together with TPE, PS, PE and the softening oil;

the temperature of die casting at a high temperature is 200° C. and its heating time is 15 minutes;

the fineness of the power milling is 600 meshes;

each component has a weight ratio of as follows:

TPE 53%, PS 10%, PE 4%, the softening oil 10%, the cornstalk 4%, the wheat stalk 3%, the rice straw 8%, and the rice bran 8%.

### Embodiment 6

Soak in clear water, bleach, dry by sun and then crush the recovered cornstalk and wheat stalk; then mill the crushed cornstalk and wheat stalk together with the rice bran and rice straw into powder; die cast at a high temperature, pump into tablets and mold the milled powder materials or the raw materials which aren't milled into powder material, together with TPE, PS, PE and the softening oil;

the temperature of die casting at a high temperature is 150° C. and its heating time is 18 minutes;

the fineness of the power milling is 700 meshes;

each component has a weight ratio of as follows:

TPE 53%, PS 11%, PE 4%, the softening oil 13%, the cornstalk 4%, the wheat stalk 8%, the rice straw 4%, and the rice bran 3%.

What is claimed is:

1. An environmentally-friendly shoe bottom comprising components having weight percent as follow:
thermoplastic elastomer (TPE) from 50% to 60%, polystyrene (PS) from 10% to 20%, polyethylene (PE) from 2% to 5%, softening oil from 10% to 20%, cornstalk from 2% to 8%, wheat stalk from 2% to 8%, rice straw from 2% to 8%, and rice bran from 2% to 8%, total combined percent is 100%.

2. The environmentally-friendly shoe bottom of claim 1, wherein a combined percent of the cornstalk, the wheat stalk, the rice straw and the rice bran is ≦28%.

3. A process for making environmentally-friendly shoe bottom comprising the following steps:
soaking cornstalks and wheat stalks in clear water;
bleaching the soaked cornstalks and wheat stalks, then drying them;
crushing the dried cornstalk and wheat stalk together with rice straws and rice bran into mixed fragments;
at a high temperature die casting the mixed fragments together with thermoplastic elastomer (TPE), polystyrene (PS), polyethylene (PE) and softening oil to become environmentally-friendly shoe bottom.

4. The process for making environmentally-friendly shoe bottom of claim 3, further mills the mixed fragments to become mixed powder, then at a high temperature die cast the mixed powder together with thermoplastic elastomer (TPE), polystyrene (PS), polyethylene (PE) and softening oil to become environmentally-friendly shoe bottom.

5. The process for making environmentally-friendly shoe bottom of claim 3, wherein the temperature of die casting is 100 to 250° C. and its heating time is 10 to 20 minutes.

6. The process for making environmentally-friendly shoe bottom of claim 4, wherein the temperature of die casting is 100 to 250° C. and its heating time is 10 to 20 minutes.

7. The process for making environmentally-friendly shoe bottom of claim 4, wherein the fineness of the power milling is 600 to 800 meshes.
